(19) United States
(12) Patent Application Publication
(10) Pub. No.: US 2023/0091362 A1
(43) Pub. Date: Mar. 23, 2023

(54) BATTERY AND METHOD OF PRODUCING THE SAME

(71) Applicant: Panasonic Intellectual Property Management Co., Ltd., Osaka (JP)

(72) Inventor: Seiji Nishiyama, Osaka (JP)

(21) Appl. No.: 18/052,577

(22) Filed: Nov. 4, 2022

Related U.S. Application Data
(63) Continuation of application No. PCT/JP2021/016255, filed on Apr. 22, 2021.

(30) Foreign Application Priority Data
May 19, 2020 (JP) 2020-087515

(51) Int. Cl. H01M 50/564; H01M 50/105; H01M 50/129; H01M 10/052; H01M 50/533; H01M 50/534

(52) U.S. Cl. CPC H01M 50/564; H01M 50/105; H01M 50/129; H01M 10/052; H01M 50/533; H01M 50/534; H01M 2220/20

(57) ABSTRACT

A battery includes a power generating element including a positive electrode layer, a negative electrode layer, and an electrolyte layer, an inner terminal electrode electrically connected to the power generating element, and a laminate film accommodating the power generating element and the inner terminal electrode. The laminate film includes a metal layer, an inner resin layer located closer to the power generating element than the metal layer, and an outer resin layer on an opposite side of the metal layer from the inner resin layer. The inner resin layer has an inner opening through which the metal layer is exposed. The inner terminal electrode is electrically connected to the metal layer through the inner opening. The inner terminal electrode and the metal layer each have an uneven surface over a contact area between the inner terminal electrode and the metal layer. The uneven surfaces engage with each other.

### BACKGROUND

### 1. Technical Field

The present disclosure relates to a battery and a method of producing the same.

### 2. Description of the Related Art

Batteries in the related art have a problem of displacement of a power generating element relative to the exterior package, which occurs when the power generating element is enfolded by the exterior package such as a laminate film. To reduce the displacement, an adhesive layer is employed in a known battery (for example, Japanese Unexamined Patent Application Publication No. 2019-164892).

Japanese Unexamined Patent Application Publication No. 2019-164892 discloses a battery including an all-solid-state battery laminate, which includes at least one all-solid-state unit cell, a positive terminal and a negative terminal respectively connected to a positive current collector layer and a negative current collector layer, and an exterior package bottom member constituting an exterior package that enfolds the all-solid-state battery laminate. The battery further includes an adhesive layer at least one of between the positive or negative current collector layer of the all-solid-state battery laminate and the exterior package bottom member or between the positive and negative terminals and the exterior package bottom member.

### SUMMARY

The battery in the related art may fail to allow the power generating element and the laminate film to be readily positioned relative to each other and to have high reliability. One non-limiting and exemplary embodiment provides a battery that allows easy positioning of a power generating element and a laminate film relative to each other and that has high reliability and provides a method of producing the same.

In one general aspect, the techniques disclosed here feature a battery that includes a power generating element including a positive electrode layer, a negative electrode layer, and an electrolyte layer between the positive electrode layer and the negative electrode layer, an inner terminal electrode electrically connected to the power generating element, and a laminate film accommodating the power generating element and the inner terminal electrode. The laminate film includes a metal layer, an inner resin layer that is located closer to the power generating element than the metal layer, and an outer resin layer on an opposite side of the metal layer from the inner resin layer. The inner resin layer has an inner opening through which the metal layer is exposed. The inner terminal electrode is electrically connected to the metal layer through the inner opening. The inner terminal electrode and the metal layer each have an uneven surface over a contact area between the inner terminal electrode and the metal layer. The uneven surface of the inner terminal electrode and the uneven surface of the metal layer engage with each other,

The present disclosure provides a battery that allows easy positioning of a power generating element and a laminate film relative to each other and that has high reliability and provides a method of producing the same.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages,

### BRIEF DESCRIPTION OF THE DRAWINGS

FIG. 1 is a sectional view illustrating a schematic configuration of a battery according to a first embodiment;

FIG. 2A is a magnified sectional view of an area IIA, IIB in FIG. 1 including structures;

FIG. 2B is a magnified exploded sectional view of the area IIA, IIB in FIG. 1 including the structures;

FIG. 3 is a plan view illustrating a positional relationship between an inner terminal electrode, an inner opening, and the structures according to the first embodiment;

FIG. 4A is a sectional view illustrating a step in a method of producing the battery according to the first embodiment.

FIG. 4B is a sectional view illustrating a step in the method of producing the battery according to the first embodiment;

FIG. 4C is a sectional view illustrating a step in the method of producing the battery according to the first embodiment;

FIG. 5 is a plan view illustrating a positional relationship between an inner terminal electrode, an inner opening, and structures according to a modification of the first embodiment;

FIG. 6 is a magnified sectional view illustrating an area including the structures of the battery according to the modification of the first embodiment;

FIG. 7 is a sectional view illustrating a schematic configuration of a battery according to a second embodiment;

FIG. 8 is a sectional view illustrating a schematic configuration of a battery according to a third embodiment; and

FIG. 9 is a sectional view illustrating a schematic configuration of a battery according to a fourth embodiment.

### DETAILED DESCRIPTIONS

Underlying Knowledge Forming Basis of the Present Disclosure

The inventor of the present disclosure found that, when the laminate film enfolds the power generating element, the following problems are caused in a battery, particularly in an all-solid-state battery.

In the configuration in the related art, a volatile substance may volatize from an adhesive constituting the adhesive layer in the sealing step. This may lower the performance of the power generating element. Furthermore, the adhesive may be contracted when cured, and the stress generated by the contraction may warp the power generating element. The warping may lower the performance of the power generating element, damage the power generating element, or detach the power generating element from the attachment portion, which results in displacement, leading to a decrease in reliability of the battery. Furthermore, the configuration in the related art requires the power generating element to be accurately positioned on a portion having the adhesive layer, making the process overly complex.

One non-limiting and exemplary embodiment provides a battery that allows easy positioning of a power generating element and a laminate film relative to each other and that has high reliability and provides a method of producing the same.

The following is a summary of an aspect of the present disclosure.

A battery according to an aspect of the present disclosure includes a power generating element including a positive electrode layer, a negative electrode layer, and an electrolyte layer between the positive electrode layer and the negative electrode layer, an inner terminal electrode electrically connected to the power generating element, and a laminate film accommodating the power generating element and the inner terminal electrode. The laminate film includes a metal layer, an inner resin layer that is located closer to the power generating element than the metal layer, and an outer resin layer on an opposite side of the metal layer from the inner resin layer. The inner resin layer has an inner opening through which the metal layer is exposed. The inner terminal electrode is electrically connected to the metal layer through the inner opening. The inner terminal electrode and the metal layer each have an uneven surface over a contact area between the inner terminal electrode and the metal layer. The uneven surface of the inner terminal electrode and the uneven surface of the metal layer engage with each other.

This configuration enables the power generating element to be readily positioned relative to the laminate film by using the uneven surface of the inner terminal electrode and the uneven surface of the metal layer. Specifically described, engagement between the uneven surface of the inner terminal electrode and the uneven surface of the metal layer positions the power generating element. Furthermore, the engagement between the uneven surface of the inner terminal electrode and the uneven surface of the metal layer reduces displacement of the power generating element, which may occur when the power generating element is accommodated by the laminate film in the process of producing the battery.

Furthermore, this configuration does not require an adhesive to position the power generating element, reducing volatilization of a volatile substance from the adhesive in the enfolding step. Thus, the performance of the power generating element is less likely to be lowered by the volatile substance. Furthermore, the absence of an adhesive reduces warping of the power generating element, which may be caused by curing of an adhesive.

As described above, a battery according to this aspect allows easy positioning of the power generating element and the laminate film relative to each other and has high reliability.

Furthermore, for example, the metal layer may include a metal layer body and a structure, and a portion of the structure may constitute a protrusion of the uneven surface of the metal layer.

This configuration enables the power generating element to be readily positioned relative to the laminate film by using the structure. Specifically described, when the structure is embedded in both the metal layer body and the inner terminal electrode, the power generating element is positioned. Furthermore, the structure embedded in the metal layer body and the inner terminal electrode reduces displacement of the power generating element, which may be caused when the power generating element is accommodated by the laminate film in the process of producing the battery.

Furthermore, this configuration does not require an adhesive to position the power generating element, reducing volatilization of a volatile substance from the adhesive in the enfolding step. Thus, the performance of the power generating element is less likely to be lowered by the volatile substance. Furthermore, the absence of an adhesive reduces warping of the power generating element, which may be caused by curing of an adhesive.

As described above, a battery according to this aspect allows easy positioning of the power generating element and the laminate film relative to each other and has high reliability.

Furthermore, the structure may be electrically conductive, for example.

This configuration increases the electrical conductivity from the power generating element to the metal layer through the inner terminal electrode, further improving the reliability of the battery.

Furthermore, the structure may be formed of metal, for example.

This configuration readily improves electrical conductivity from the power generating element to the metal layer through the inner terminal electrode, further improving the reliability of the battery.

Furthermore, the structure may be a spherical particle, for example.

This configuration reduces the contact area between each of the inner terminal electrode and the metal layer body and the structure in the process of producing the battery, allowing greater pressure to be applied to contact positions between each of the inner terminal electrode and the metal layer body and the structure. Thus, the structure is readily embedded in the metal layer body and the inner terminal electrode, reducing displacement of the power generating element. This further improves the reliability of the battery.

Furthermore, for example, the inner terminal electrode may be in contact with a side surface and a main surface of the power generating element.

This configuration allows the power generating element to support the inner terminal electrode on multiple surfaces. Thus, the power generating element is less likely to be displaced in the process of producing the battery. This further improves the reliability of the battery.

Furthermore, for example, the outer resin layer may have an outer opening through which the metal layer is exposed.

This configuration enables current draw from the power generating element through the outer opening via the metal layer. This increases, for example, freedom in design for current draw from the battery.

Furthermore, for example, the battery according to an aspect of the present disclosure may further include an outer terminal electrode electrically connected to the metal layer through the outer opening.

This configuration allows the outer terminal electrode to draw current through the outer opening. This increases freedom in design such as positioning of the outer terminal electrode.

Furthermore, for example, a portion of the metal layer exposed through the inner opening may be thicker than an unexposed portion of the metal layer.

This allows the protrusion of the uneven surface to increase in size, further reducing displacement of the power generating element in the process of producing the battery. Furthermore, this reduces damage to the metal layer in a contact region between the protrusion of the uneven surface and the metal layer. This further improves the reliability of the battery. Furthermore, since the metal layer of the laminate film is not thick over the entire area, the weight of the laminate film is unlikely to increase. This increases the gravimetric energy density of the battery. Furthermore, this allows the laminate film to keep flexibility, increasing productivity of the battery, and resulting in a lower cost.

Furthermore, for example, the electrolyte layer may be a solid electrolyte layer including a solid electrolyte that conducts lithium ions.

In this configuration, a battery including a solid electrolyte that conducts lithium ions allows the power generating element and the laminate film to be readily positioned relative to each other and has higher reliability.

Furthermore, a method of producing a battery according to an aspect of the present disclosure is a method of producing a battery that includes a power generating element including a positive electrode layer, a negative electrode layer, and an electrolyte layer between the positive electrode layer and the negative electrode layer, an inner terminal electrode, and a laminate film accommodating the power generating element and the inner terminal electrode. The method includes providing the laminate film including a metal layer and an inner resin layer, the inner resin layer being located closer to the power generating element than the metal layer and having an inner opening through which the metal layer is exposed, placing a structure in the inner opening, and pressing the inner terminal electrode electrically connected to the power generating element to be electrically connected to the metal layer through the inner opening having the structure placed in the placing.

In this method, the power generating element is positioned when the structure is embedded in the metal layer body and the inner terminal electrode. Furthermore, in the process of producing the battery, this method reduces displacement of the power generating element, which may be caused when the power generating element is accommodated by the laminate film, because the structure is embedded in the metal layer body and the inner terminal electrode.

Furthermore, this method does not require an adhesive to position the power generating element, reducing volatilization of a volatile substance from the adhesive in the enfolding step. Thus, the performance of the power generating element is less likely to be lowered by the volatile substance. Furthermore, the absence of an adhesive reduces warping of the power generating element, which may be caused by curing of an adhesive.

As described above, this aspect provides a battery that allows easy positioning of the power generating element and the laminate film relative to each other and that has high reliability.

Hereinafter, embodiments will be described in detail with reference to the drawings.

The embodiments described below are general or specific examples. Numbers, shapes, materials, components, positions and connection of the components, the production process, order of steps in the production process, and the like in the following embodiments are examples and are not intended to be limiting of the disclosure. The components of the following embodiments that are not included in an independent claim are optional.

In addition, the diagrams are schematic drawings and are not necessarily strictly to scale. Accordingly, scale sizes, for example, may be different for different diagrams. Furthermore, the same reference numerals are assigned to substantially the same components in the drawings without duplicated or detailed explanation.

In addition, terms indicating relationships between components, such as parallel and perpendicular, terms indicating shapes of components, such as rectangular and circular, and numerical ranges in this specification are not strictly limited to the terms and the ranges. The range may include approximation to the range, e.g., variations of a few percent.

Furthermore, in this specification, when a battery is viewed in “plan view”, the battery is viewed in a laminating direction of the battery, and the view is called a plan view. In this specification, the “thickness” is a dimension of the battery or each layer measured in the laminating direction.

Furthermore, the term “inner” used herein refers to a direction toward the center of a battery and the term “outer” used herein refers to a direction away from the center of a battery, unless otherwise specified.

Furthermore, the terms “upper” and “lower” used herein to describe the configuration of the battery are not meant to refer to the upward direction (vertically upward) and the downward direction (vertically downward) in absolute spatial awareness. The terms are meant to refer to the relative positional relationship based on the laminating order of the laminating configuration. Furthermore, the terms “above” and “below” are not limited to indicate a case where two components are spaced apart from each other with another component being therebetween and are used to indicate a case where two components are positioned close to each other and a case where two components are in contact with each other.

Furthermore, in the specification and the drawings, the x, y, and z axes are three axes of a three-dimensional orthogonal coordinate system. In the embodiments, the upper surface of the power generating element and the xy plane are parallel to each other, and the direction perpendicular to the xy plane is the z axis direction. Furthermore, in the embodiments described below, the positive z direction is referred to as “above” and the negative z direction is referred to as “below” in some cases.

First Embodiment

1. Outline of Battery

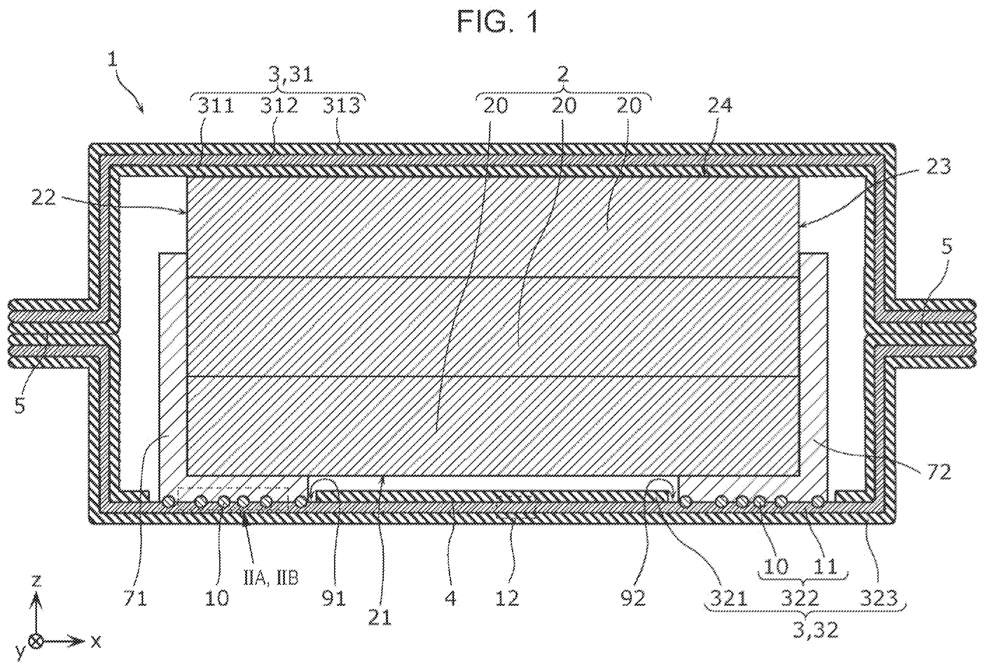

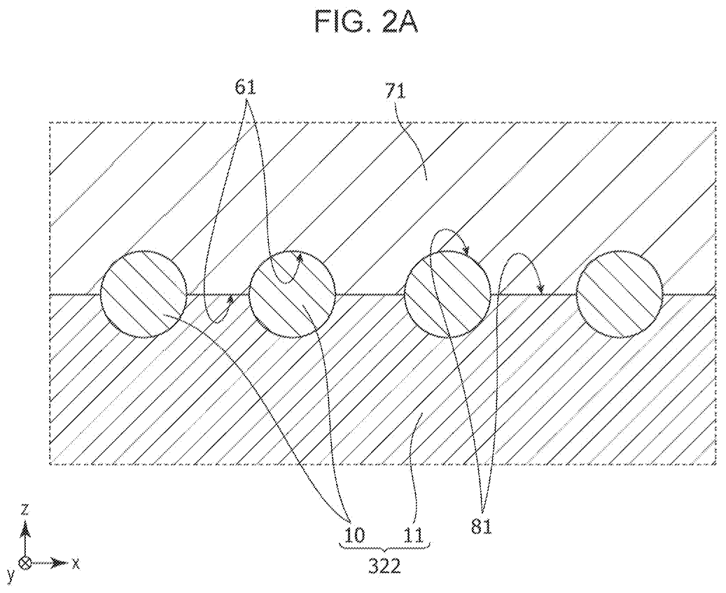

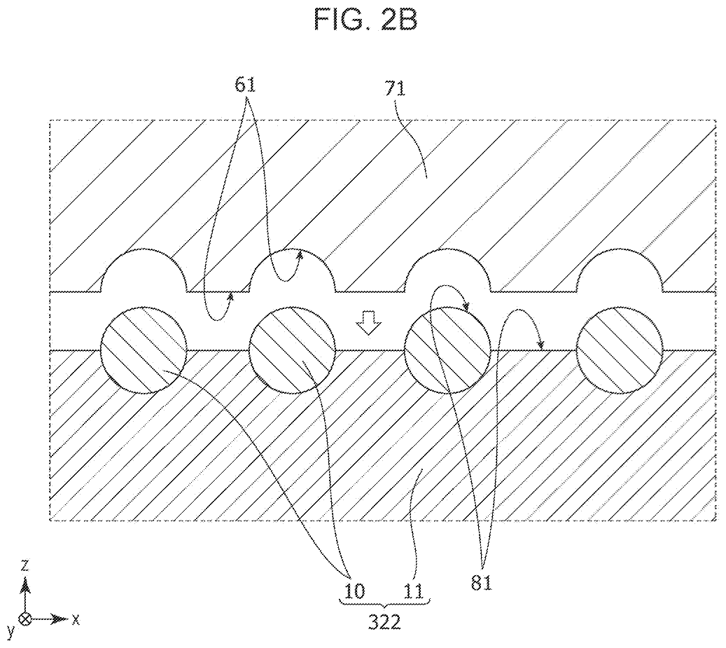

First, an outline of a battery according to a first embodiment will be described with reference to FIGS. 1 and 2A. FIG. 1 is a sectional view illustrating a schematic configuration of a battery 1 according to the embodiment. FIG. 2A is a magnified sectional view of an area IIA, IIB in FIG. 1 including structures 10.

As illustrated in FIG. 1, the battery 1 includes a power generating element 2, inner terminal electrodes 71 and 72, and a laminate film 3.

In the battery 1, the power generating element 2 and the inner terminal electrodes 71 and 72 are accommodated and sealed by the laminate film 3. The laminate film 3 includes a first laminate film 31, a second laminate film 32, and a sealing portion 5. The first laminate film 31 includes an inner resin layer 311, a metal layer 312, and an outer resin layer 313. The second laminate film 32 includes an inner resin layer 321, a metal layer 322, and an outer resin layer 323. The inner resin layer 321 of the second laminate film 32 has inner openings 91 and 92 through which the metal layer 322 is exposed. The metal film 322 of the second laminate film 32 includes a metal layer body 11 and the structures 10.

The inner terminal electrodes 71 and 72 are, respectively, in contact with side surfaces 22 and 23 and are in contact with a main surface (here, a bottom surface 21) of the power generating element 2 to draw current from the power generating element 2. The inner terminal electrodes 71 and 72 are electrically connected to the metal layer 322, respectively, through the inner openings 91 and 92.

As illustrated in FIG. 2A, in this embodiment, the inner terminal electrode 71 and the metal layer 322, respectively, have an uneven surface 61 and an uneven surface 81 over a contact area between the inner terminal electrode 71 and the metal layer 322. The uneven surface 61 of the inner terminal electrode 71 and the uneven surface 81 of the metal layer 322 engage with each other.

Furthermore, the protrusions of the uneven surface 81 of the metal layer 322 are portions of the structures 10.

In other words, the structures 10 are embedded in both the inner terminal electrode 71 and the metal layer body 11.

As illustrated in FIG. 1, the inner terminal electrode 72 and a portion of the metal layer 322 in the inner opening 92 also have the above-described configuration.

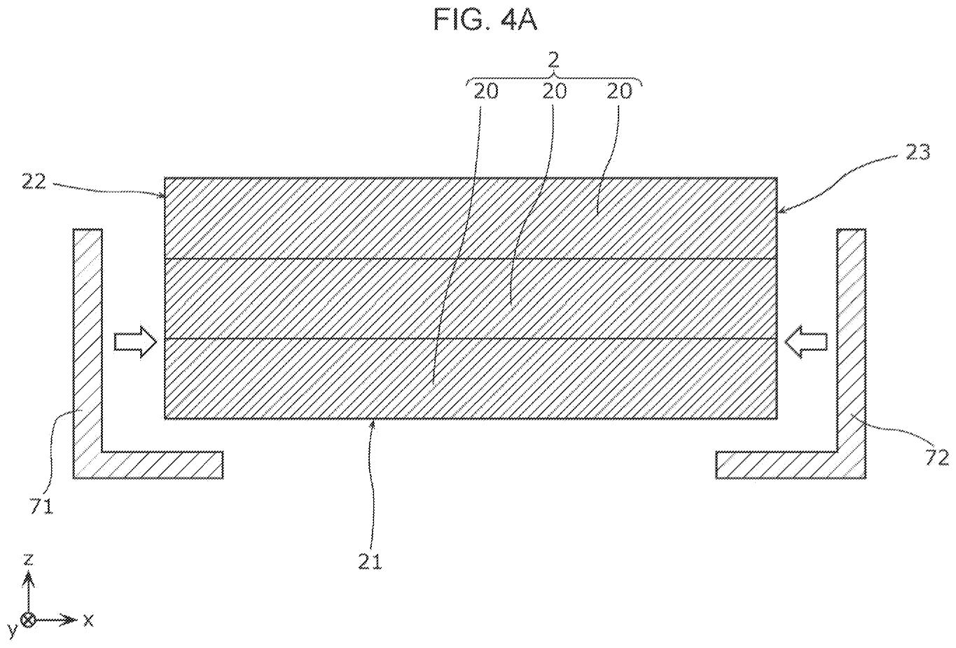

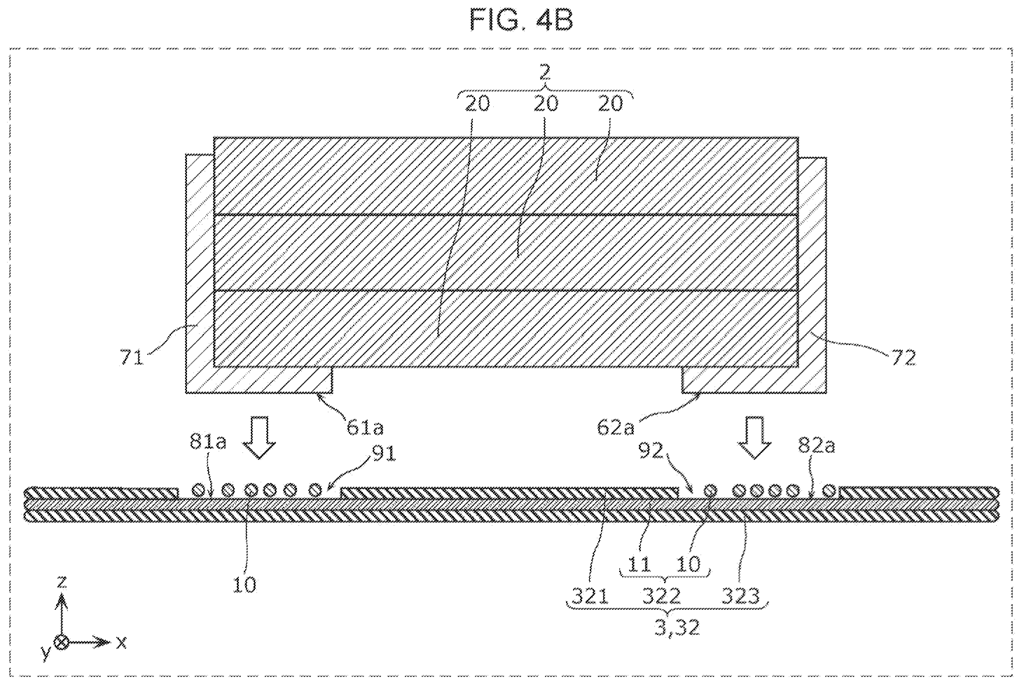

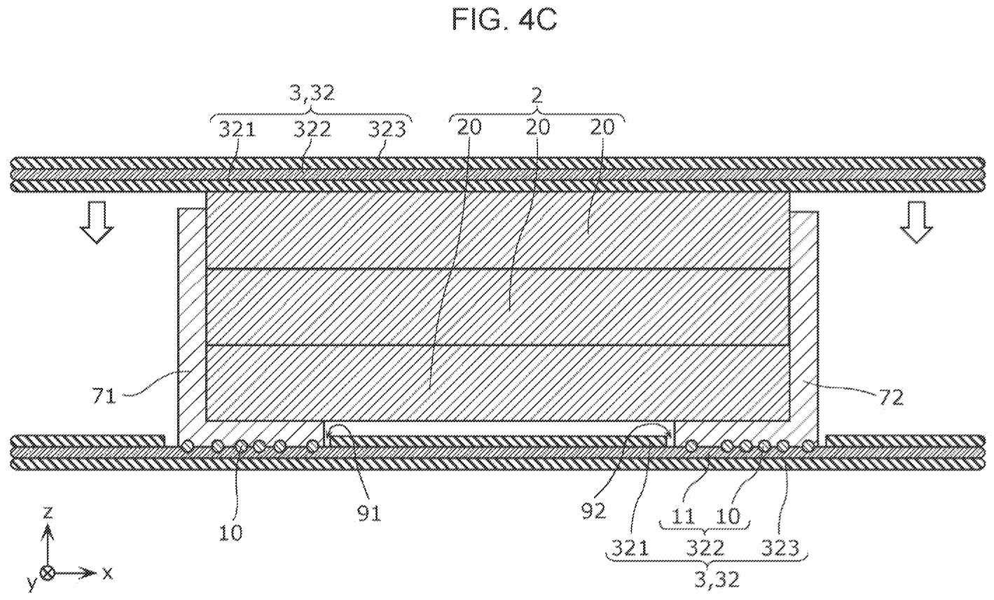

Next, the function of the structure 10 will be described first. The structure 10 is functional mainly at the step of sealing the power generating element 2 with the laminate film 3. The sealing step is performed in a lower pressure space of a lower pressure chamber. The sealing step will be briefly described below and will be described in detail later with reference to FIGS. 4A to 4C.

First, in the sealing step, the second laminate film 32 having the inner openings 91 and 92 is placed in a lower pressure chamber. The inner openings 91 and 92 extend in the y axis direction in FIG. 1.

Furthermore, the power generating element 2 having the inner terminal electrodes 71 and 72 is placed above the second laminate film 32. At this time, the structures 10 are positioned above the metal film body 11 in the inner openings 91 and 92, and the inner terminal electrodes 71 and 72 of the power generating element 2. are positioned above the inner openings 91 and 92 with the structures 10 therebetween. In this state, the power generating element 2 and the inner terminal electrodes 71 and 72 are pressed, and thus the structures 10 are embedded in the inner terminal electrodes 71 and 72 and the metal layer body 11. The structures 10 in this state keep the power generating element 2 from moving relative to the second laminate film 32, or fix the position of the power generating element 2. In other words, the power generating element 2 is positioned.

The first laminate film 31 is placed to cover the power generating element 2 to enfold the power generating element 2 together with the structures 10. In such a state, the pressure in the lower pressure chamber is reduced to attach the end of the first laminate film 31 and the end of the second laminate film 32 together. In this way, the sealing portions 5 are formed to surround the first laminate film 31 and the second laminate film 32.

After the attachment, the pressure is returned to an ordinary pressure, and thus the first and second laminate films 31 and 32 cover the power generating elements 2 due to the pressure of the atmosphere. When the pressure is returned to an ordinary pressure, the power generating element 2 is subjected to an external force generated by an atmospheric airflow caused by the increase in pressure to an ordinary pressure and an external force generated by deformation and displacement of the laminate film 3 caused by the airflow. Without the structures 10, the power generating element 2 may be moved and displaced by the external force. In the battery I according to the present embodiment, the structures 10 are embedded in the inner terminal electrodes 71 and 72 and the metal film body 11. This configuration limits the movement of the power generating element 2 when the external force is applied to the power generating element 2, reducing displacement of the power generating element 2.

Furthermore, since this configuration does not have an attachment portion using an adhesive, the performance of the power generating element 2 is not lowered by a volatile substance in the adhesive, the power generating element 2 is not deformed and damaged, and the power generating element 2 is not detached from the attachment portion by the deformation.

2. Configuration

Next, a specific configuration of the battery 1 according to the present embodiment will be described with reference back to FIG. 1. As illustrated in FIG. 1, the battery 1 according to the present embodiment includes the power generating element 2 that includes laminates of a positive electrode layer, a negative electrode layer, and a solid electrolyte layer, the inner terminal electrodes 71 and 72, and the laminate film 3. The battery I is, for example, an all-solid-state battery.

First, the specific configuration of the power generating element 2 is described.

The power generating element 2 includes at least one battery cell 20. In this embodiment, the power generating element 2 includes three battery cells 20. The three battery cells 20 are laminated and electrically connected in series. The battery cells 20 are each a laminate including, in this order, a positive electrode layer, an electrolyte layer, and a negative electrode layer. The battery cells 20 each include a first electrode layer, a second electrode layer, and a solid electrolyte layer. The first electrode layer includes a first current collector and a first active material layer. The first active material layer is positioned between the first current collector and the solid electrolyte layer. The second electrode layer includes a second current collector and a second active material layer. The second active material layer is positioned between the second current collector and the solid electrolyte layer.

In the following example, the first electrode layer is a positive electrode layer, and the second electrode layer is a negative electrode layer. The first current collector is a positive current collector, and the first active material layer is a positive electrode active material layer. The second current collector is a negative current collector, and the second active material layer is a negative electrode active material layer. In other words, in this embodiment, each of the battery cells 20 is a laminate including, in this order, the positive current collector, the positive electrode active material layer, the solid electrolyte layer, the negative electrode active material layer, and the negative current collector,

The first electrode layer may be a negative electrode layer, and the second electrode layer may be a positive electrode layer. The first current collector may be a negative current collector, and the first active material layer may include a negative electrode active material. The second current collector may be a positive current collector, and the second active material layer may include a positive electrode active material.

The first current collector, the first active material layer, the solid electrolyte layer, the second active material layer, and the second current collector each have a rectangular shape in plan view. The first current collector, the first active material layer, the solid electrolyte layer, the second active material layer, and the second current collector each may have any shape in plan view and may have a square shape or a non-rectangular shape, such as a circular shape, an elliptical shape, and a polygonal shape. In other words, the battery cell 20, which is a laminate including the first current collector, the first active material layer, the solid electrolyte layer, the second active material layer, and the second current collector, has one of the above shapes.

Furthermore, in the present embodiment, the first current collector, the first active material layer, the solid electrolyte layer, the second active material layer, and the second current collector have the same size and the same outlines in plan view. However, the present embodiment should not be limited to this. For example, the first active material layer may be smaller than the second active material layer. The first and second active material layers may be smaller than the solid electrolyte layer.

The first and second current collectors may be formed of a known electrically conductive material. The first and second current collectors each may be, for example, a foil-like, plate-like, or mesh-like current collector formed of copper, aluminum, nickel, iron, stainless steel, platinum, gold, or an alloy of two or more of these.

The first active material layer, which is the positive electrode active material layer, includes at least a positive electrode active material. The first active material layer may include at least one of a solid electrolyte, a conductive additive, or a binding agent (or a binder) as necessary.

The positive electrode active material may be a known material that allows intercalation and deintercalation (insertion and extraction, or dissolution and precipitation) of lithium ions, sodium ions, or magnesium ions. Examples of the positive electrode active material that allows intercalation and deintercalation of lithium ions include a composite oxide of lithium cobalt oxide (LCO), a composite oxide of lithium nickel oxide (LNO), a composite oxide of lithium manganese oxide (LMO), a lithium-manganese-nickel composite oxide (LMNO), a lithium-manganese-cobalt composite oxide (LMCO), a lithium-nickel-cobalt composite oxide (LNCO), and a lithium-nickel-manganese-cobalt composite oxide (LNMCO).

The solid electrolyte may be a known material, such as a lithium-ion conductor, a sodium ion conductor, or a magnesium ion conductor. The solid electrolyte may be any one of an inorganic solid electrolyte and a solid polymer electrolyte (including a gel-like solid electrolyte). Examples of the inorganic solid electrolyte include a solid sulfide electrolyte and a solid oxide electrolyte.

The solid sulfide electrolyte that conducts lithium ions may be a compound of lithium sulfide (Li₂S) and phosphorus pentasulfide (P₂S₅). The solid sulfide electrolyte may be sulfide, such as Li₂S—SiS₂, Li₂S—B₂S₃, or Li₂S—GeS₂. Alternatively, the solid sulfide electrolyte may be sulfide including the above sulfide and an additive including at least one of Li₃N, LiCl, LiBr, Li₃PO₄, or Li₄SiO₄, for example.

The solid oxide electrolyte that can conduct lithium ions may be, for example, Li₇La₃Zr₂O₁₂ (LLZ), Li_{1.3}Al_{0.3}Ti_{1.7} (PO₄)₃(LATP), or (La, Li) TiO₃ (LLTO).

The conductive additive may be a conductive material, such as acetylene black, carbon black, graphite, or carbon fiber. The binding agent may be a binder, such as polyvinylidene fluoride.

The second active material layer, which is a negative electrode active material layer, includes at least a negative electrode active material. The second active material layer may include at least one of a solid electrolyte, a conductive additive, or a binding agent as necessary similarly to the positive electrode active material layer.

The negative electrode active material may be a known material that allows intercalation and deintercalation (insertion and extraction, or dissolution and precipitation) of lithium ions, sodium ions, or magnesium ions. Examples of the negative electrode active material that allows intercalation and deintercalation of lithium ions include natural graphite, artificial graphite, a carbon material, such as graphite carbon fiber and resin heat-treated carbon, metallic lithium, lithium alloy, and an oxide of lithium and a transition metal element.

The solid electrolyte layer includes at least a solid electrolyte. The solid electrolyte layer may include a binding agent as necessary. The solid electrolyte layer may include a solid electrolyte that conducts lithium ions. Examples of the solid electrolyte and the binding agent in the solid electrolyte layer include the above-listed solid electrolytes and binding agents.

The power generating element 2 only needs to include at least one battery cell 20. As in the present embodiment, when the power generating element 2 includes multiple battery cells 20, the battery cells 20 may be laminated on top of another. The battery cells 20 may be laminated in any form that allows the battery cells 20 to function as a battery. For example, the battery cells 20 are laminated to be electrically connected in series. Alternatively, the battery cells 20 may be laminated to be connected in parallel. The number of battery cells 20 included in the power generating element 2 may be two or higher than or equal to three but should not be limited thereto.

The adjacent battery cells 20 of the battery cells 20 may share the positive current collector or the negative current collector. In other words, the positive electrode layer or the negative electrode layer of one battery cell 20 does not need to include a current collector and may include a positive electrode active material layer or a negative electrode active material layer on the current collector of the adjacent battery cell 20. The side surfaces 22 and 23 of the battery cells 20 may be covered by a sealant such as a sealing resin.

Next, the laminate film 3 including the first and second laminate films 31 and 32 will be described.

The laminate film 3 is an exterior package formed of a flexible film and accommodates the power generating element 2 and the inner terminal electrodes 71 and 72. The laminate film 3 covers the surface of the power generating element 2 to protect the power generating element 2 from moisture and air, for example. The laminate film 3 includes the first laminate film 31, the second laminate film 32, and the sealing portion 5 including a. portion of the first laminate film 31 and a. portion of the second laminate film 32 attached to each other.

For example, after the laminate film 3 covers and accommodates the power generating element 2 under reduced pressure, the pressure in the space outside the laminate film 3 is increased to atmospheric pressure. This allows the laminate film 3 to be in close contact with the power generating element 2. Although the example illustrated in FIG. 1 has spaces, for example, between the laminate film 3 and the side surfaces 22 and 23 of the power generating element 2, the actual spaces are small enough to be unrecognizable.

The first laminate film 31 is a film covering the upper surface 24 of the power generating elements 2. The second laminate film 32 is a film covering the bottom surface 21 of the power generating element 2. The first laminate film 31 includes the metal layer 312, the inner resin layer 311, and the outer resin layer 313. The second laminate film 32 includes the metal layer 322, the inner resin layer 321, and the outer resin layer 323.

The inner resin layers 311 and 321 are located closer to the power generating element 2 than the metal layers 312 and 322 are. The outer resin layer 313 is on the opposite side of the metal layer 312 from the inner resin layer 311. The outer resin layer 323 is on the opposite side of the metal layer 322 from the inner resin layer 321. The first laminate film 31 includes, in this order toward the center of the battery, the outer resin layer 313, the metal layer 312, and the inner resin layer 311. The second laminate film 32 includes, in this order toward the center of the battery, the outer resin layer 323, the metal layer 322, and the inner resin layer 321.

The inner resin layer 321 of the second laminate film 32 has the inner openings 91 and 92 through which the metal layer 322 is exposed. In other words, the metal layer 322 has portions not covered by the inner resin layer 321 at the inner openings 91 and 92. As described later, the inner terminal electrodes 71 and 72 of the battery 1 are electrically connected to the metal layer 322 through the inner openings 91 and 92, respectively. The inner openings 91 and 92 are openings in the inner resin layer 321 that are shaped in conformity with the inner terminal electrodes 71 and 72.

The metal layer 322 has the uneven surface Si over a contact area between the inner terminal electrodes 71 and 72 and the metal layer 322. The uneven surface 81 is an upper surface of the metal layer 322 in the inner openings 91 and 92.

Here, the metal layer 322 and the uneven surface 81 are described in more detail with reference to FIG. 2A and FIG. 2B.

FIG. 2B is a magnified exploded sectional view of the area IIA, IIB in FIG. 1 including the structures 10.

As illustrated in FIGS. 2A and 2B, in the present embodiment, the metal layer 322 includes the metal layer body 11 and the structures 10. The structures 10 are particles located between the metal layer body 11 and the inner terminal electrodes 71 and 72.

The structures 10 are spherical particles. The shape of the structures 10 may be a cuboid or a cube. The size of the structure 10 is defined as the longest side of a minimum cuboid that can house the whole structure 10. The size of the structure 10 may be greater than or equal to a few μm and less than or equal to a few tens of μm. The structure 10 is electrically conductive and is particularly formed of a low-resistance metal. Specifically described, the structure 10 is formed of a stainless steel, for example. The structure 10 may be formed of molybdenum or tungsten, for example. The structure 10 may be formed of, for example, a non-conductive resin. In such a case, the structure 10 may be covered with a conductive material to have electrical conductivity.

The structures 10 having conductivity described above improve electrical conductivity from the power generating element 2 to the metal layer 322 through the inner terminal electrodes 71 and 72 (described later). This, for example, reduces the electric conduction loss between the inner terminal electrodes 71 and 72 and the metal layer 322, or reduces a decrease in the performance of the power generating element 2. This further improves the reliability of the battery 1.

The structure 10 may be formed of any material but may preferably be formed of metal to secure stable electrical connection between the inner terminal electrodes 71 and 72 and the metal layer 322. This readily increases the electrical conductivity from the power generating element 2 to the metal layer 322, resulting in a further improvement of the reliability of the battery 1.

When the pressure is returned to an atmospheric pressure to seal the power generating element 2 with the laminate film 3, an external force is applied to the power generating element 2. Thus, the structures 10 are preferably formed of a material having enough hardness, strength, and elasticity to, for example, limit the movement of the power generating element 2 caused by the external force.

In the above-described configuration in which the metal layer 322 includes the structures 10, the uneven surface 81 is constituted by a surface of the metal layer body 11 and surfaces of the structures 10. In this embodiment, the protrusions of the uneven surface 81 are portions of the structures 10. In other words, the other portions of the structures 10 are embedded in the metal layer body 11. The structure 10 has a spherical shape, and thus the protrusions of the uneven surface 81 each have a semi-spherical shape. Furthermore, as illustrated in FIG. 2A, the uneven surface 81 of the metal layer 322 and an uneven surface (e.g., an uneven surface 61 of the inner terminal electrode 71) of each of the inner terminal electrodes 71 and 72 (described later) engage with each other,

Furthermore, the metal layer 322 has an insulating area 12 indicated by a dashed rectangle in FIG. 1. The insulating area 12 is an area extending in the y axis direction in this embodiment. The insulating area 12 provides insulation between a section of the metal layer 322 located in the x axis direction negative to the insulating area 12 and a section of the metal layer 322 located in the x axis direction positive to the insulating area 12.

The inner resin layers 311 and 321 and the outer resin layers 313 and 323 are resin layers formed of resin, such as a polyethylene resin and a polypropylene resin. The metal layer 312 and the metal layer body 11 are layers formed of metal such as aluminum. The metal layer 312 and the metal layer body 11 each have a thickness of, for example, greater than or equal to a few tens of μm and less than or equal to 1 mm. The thickness of the metal layer 312 and the metal layer body 11 is preferably larger than half of the thickness of one structure 10 to prevent entry of moisture and oxygen from the outside of the battery 1. The thickness of the metal layer 312 and the metal layer body 11 may be greater than or equal to about two times and less than or equal to about 10 times the thickness of one structure 10, for example. The first laminate film 31 is a film having a laminate of the above materials and may be a known laminate film. The second laminate film 32 may be a film including the above known laminate film and the structures 10 forming a portion of the metal layer 322. The first and second laminate films 31 and 32 each have a three-layer structure. The first laminate film 31 includes, in this order, the inner resin layer 311, the metal layer 312, and the outer resin layer 313. The second laminate film 32 includes, in this order, the inner resin layer 321, the metal layer 322, and the outer resin layer 323. The number of layers of each of the first and second laminate films 31 and 32 should not be limited to three and may be any number required for the specification and the purpose.

The sealing portion 5 is constituted by end portions of the first and second laminate films 31 and 32 attached together. In this embodiment, the first laminate film 31 and the second laminate film 32 are in close contact with each other at the outer end portions and sealed to form the sealing portion 5. The sealing portion 5 has, for example, a looped shape surrounding the power generating element 2 in plan view.

The laminate film 3 may be formed by bending one laminate film, Specifically described, the first laminate film 31 may be a portion of one laminate film and the second laminate film 32 may be the other portion of the laminate film,

The laminate film 3 having the above-described configuration has high flexibility and functions as an exterior package with high barrier properties against air and moisture.

The inner terminal electrodes 71 and 72 are terminals that draw current from the power generating element 2. Specifically described, the power generating element 2 includes positive electrode tabs and negative electrode tabs, which function as electrode lead-out portions. The inner terminal electrodes 71 and 72 draw current through the positive electrode tabs and the negative electrode tabs. One of the inner terminal electrodes 71 and 72 is connected to one of the plurality of positive electrode tabs and the plurality of negative electrode tabs, for example, by soldering. The other of the inner terminal electrodes 71 and 72 is connected to the other of the plurality of positive electrode tabs and the plurality of negative electrode tabs, for example, by soldering.

The positive electrode tabs are pulled out from one of end portions of the power generating element 2 (e.g., the side surface 22) and put together. The positive electrode tabs put together are fixed to the bottom surface 21 of the power generating element 2 by, for example, binding. The negative electrode tabs are pulled out from the other of the end portions of the power generating element 2 (e.g., the side surface 23) and put together. The negative electrode tabs put together are fixed to the bottom surface 21 of the power generating element 2 by, for example, binding.

The inner terminal electrodes 71 and 72 are terminals and are in contact with the side surface 22 and 23, respectively, and the main surface (the bottom surface 21 in one example) of the power generating element 2. As illustrated in FIG. 1, the inner terminal electrodes 71 and 72 each have an L-like shape in sectional view. However, the shape of the inner terminal electrodes 71 and 72 should not be limited to the above-described shape. The inner terminal electrodes 71 and 72 may have a plate-like shape to support the bottom surface 21 of the power generating element 2. The inner terminal electrodes 71 and 72 may have a shape that can support the side surfaces 22 and 23, the bottom surface 21, and the upper surface 24 of the power generating element

The inner terminal electrodes 71 and 72 are electrically connected to the metal layer 322 through the inner openings 91 and 92, respectively. This allows the metal layer 322 to draw current from the power generating element 2 through the inner terminal electrodes 71 and 72. As described above, the insulating area 12 provides insulation between the section of the metal layer 322 located in the x axis direction negative to the insulating area 12 and the section of the metal layer 322 located in the x axis direction positive to the insulating area 12. The inner terminal electrodes 71 and 72 are not electrically connected to each other through the metal layer 322.

The inner terminal electrodes 71 and 72 each have an uneven surface over a contact area between the inner terminal electrode 71 or 72 and the metal layer 322. Specifically described, in this embodiment, the uneven surfaces of the inner terminal electrodes 71 and 72 are the bottom surfaces of the inner terminal electrodes 71 and 72. The bottom surfaces of the inner terminal electrodes 71 and 72 are surfaces of the inner terminal electrodes 71 and 72 facing in the negative z direction.

Here, the inner terminal electrode 71 and the uneven surface 61 of the inner terminal electrode 71 will be described in more detail with reference to FIGS. 2A and 2B. As described above, the metal layer 322 includes the metal layer body 11 and the spherical structures 10, and the uneven surface 81 of the metal layer 322 is constituted by a surface of the metal layer body 11 and surfaces of the structures 10. In this configuration, the protrusions of the uneven surface Si of the metal layer 322 are semispherical and the recesses of the uneven surface 61 of the inner terminal electrode 71 are semi spherical. The recesses of the uneven surface 61 of the inner terminal electrode 71 may have any shape if shaped in conformity with the protrusions of the uneven surface 81 of the metal layer 322.

As illustrated in FIG. 2A, the uneven surface 61 of the inner terminal electrode 71 and the uneven surface 81 of the metal layer 322 engage with each other. The protrusions of the uneven surface 81 of the metal layer 322 are in the recesses of the uneven surface 61 of the inner terminal electrode 71. In other words, the structures 10 are embedded in both the inner terminal electrode 71 and the metal layer body 11. The same holds for the inner terminal electrode 72. The uneven surface of the inner terminal electrode 72 and the uneven surface 81 of the metal layer 322 engage with each other.

The inner terminal electrodes 71 and 72 may be formed of any electrically conductive material and may be formed of metal, for example. In one example, the inner terminal electrodes 71 and 72 are formed of aluminum but may be formed of any highly conductive material.

The inner terminal electrodes 71 and 72 have insulated surfaces to reduce electrical defects in the battery 1 (such as leakage and a short circuit). However, the surfaces of the inner terminal electrode 71 are not insulated, for example, over areas in contact with the power generating element 2. and the metal layer 322 to enable current draw. The inner terminal electrode 72 has the same configuration to enable current draw.

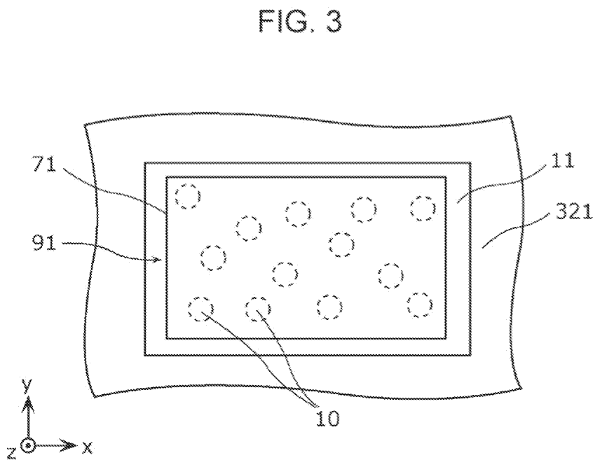

Furthermore, positions of connection between the inner terminal electrodes 71 and 72 and the metal layer 322 will be described with reference to FIG. 3. Here, the inner terminal electrode 71 is used for the description, but the same holds for the inner terminal electrode 72.

FIG. 3 is a plan view illustrating the positional relationship between the inner terminal electrode 71, the inner opening 91, and the structures 10 according to this embodiment. The inner terminal electrode 71 is positioned in the rectangular inner opening 91 in plan view. Furthermore, the structures 10 are positioned in an area overlapping the inner terminal electrode 71 in plan view (or an area corresponding to the bottom surface of the inner terminal electrode 71).

3. Production Method.

Next, a method of producing the battery 1 according to this embodiment will be described with reference to FIGS. 4A to 4C. FIGS. 4A to 4C are sectional views each illustrating a step in a method of producing the battery 1 according to the present embodiment. The method of producing the battery 1 described below is an example and the method of producing the battery 1 should not be limited to the example.

First, the power generating element 2 including three battery cells 20 laminated on top of another is provided. The three battery cells 20 are each produced by, for example, a known method in which a positive electrode active material, a solid electrolyte, and a negative electrode active material are laminated on a current collector, for example, by application. The three battery cells are laminated to be connected in series. However, the three battery cells 20 may be laminated to be connected in parallel. The power generating element 2 is produced in this way.

Next, as illustrated in FIG. 4A, the inner terminal electrodes 71 and 72 are connected to the power generating element 2. The inner terminal electrodes 71 and 72 are in contact with the side surface 22 and 23, respectively, and the main surface(e.g., the bottom surface 21) of the power generating element 2.

Then, as illustrated in FIG. 4B, for example, the second laminate film 32 having three layers including, in this order, a resin layer, an aluminum layer, and a resin layer is provided in a lower pressure chamber.

Furthermore, the second laminate film 32 has the inner openings 91 and 92. The inner openings 91 and 92 extend in the y axis direction in FIG. 4B.

Furthermore, the power generating element 2 to which the inner terminal electrodes 71 and 72 are connected is placed on the second laminate film 32. At this time, the structures 10 are positioned above the metal layer body 11 in each of the inner openings 91 and 92, and the inner terminal electrodes 71 and 72 on the power generating element 2 are positioned above the inner openings 91 and 92 with the structures 10 therebetween.

As illustrated in FIG. 4B, at this time, bottom surfaces 61a and 62a of the inner terminal electrodes 71 and 72, and surfaces 81a and 82a of the metal layer body 11 in the inner openings 91 and 92 are flat.

The inner terminal electrodes 71 and 72 are pressed to be electrically connected to the metal layer 322 through the inner openings 91 and 92 having the structures 10. In other words, when the power generating element 2 and the inner terminal electrodes 71 and 72.

are pressed, the structures 10 are embedded in the inner terminal electrodes 71 and 72 and the metal layer body 11.

Next, as illustrated in FIG. 4C, the first laminate film 31 is placed on an upper surface of the power generating element 2. In other words, the first and second laminate films 31 and 32 sandwich and cover the power generating element 2.

The first and second laminate films 31 and 32 are attached together at the end portions except for some portions by thermocompression bonding such that the first and second laminate films 31 and 32 are formed into a pouch-like laminate film 3.

The pressure in the space outside the pouch-like laminate film 3 accommodating the power generating element 2 is reduced in the lower pressure chamber. Under the reduced pressure, the portions that were not compressed are subjected to thermocompression, and thus the power generating element 2 is sealed by the laminate film.

After the sealing, the pressure in the lower pressure chamber is increased to the atmospheric pressure. This brings the laminate film 3 to be in close contact with the power generating element 2 due to an external force generated by, for example, the airflow and the atmospheric pressure. The battery 1 illustrated in FIG. 1 is produced in this way. The structures 10 embedded in the inner terminal electrodes 71 and 72 and the inner openings 91 and 92 reduce the possibility that the power generating element 2 will be displaced by the external force generated by the increase in the pressure.

Furthermore, in this embodiment, the structures 10 are spherical. Thus, when the power generating element 2 is pressed, the inner terminal electrode 71 and the metal layer body 11 come in contact with the structures 10 over a small area. Specifically described, high pressure is applied to contact regions between each of the inner terminal electrode 71 and the metal layer body 11 and the structures 10, allowing the structures 10 to be readily embedded in the inner terminal electrode 71 and the metal layer body 11. The same holds for the inner terminal electrode 72. This reduces the displacement of the power generating element 2, resulting in a further improvement of the reliability of the battery I

Furthermore, in this embodiment, the inner terminal electrodes 71 and 72 are in contact with the side surfaces 22 and 23 and the bottom surface 21 of the power generating element 2. The power generating element 2 is supported at the multiple surfaces. This reduces the displacement of the power generating element 2 caused by the external force. This further improves the reliability of the battery 1.

Although the above-described example includes, before the first laminate film 31 is placed on the upper surface of the power generating element 2, the step of pressing the power generating element 2 and the inner terminal electrodes 71 and 72, the present disclosure should not be limited to the example. For example, the step of pressing may be eliminated, and after the step of sealing, the pressure in the lower pressure chamber may be increased to the atmospheric pressure to allow the power generating element 2 and the inner terminal electrodes 71 and 72 to be pressed.

Modification of First Embodiment

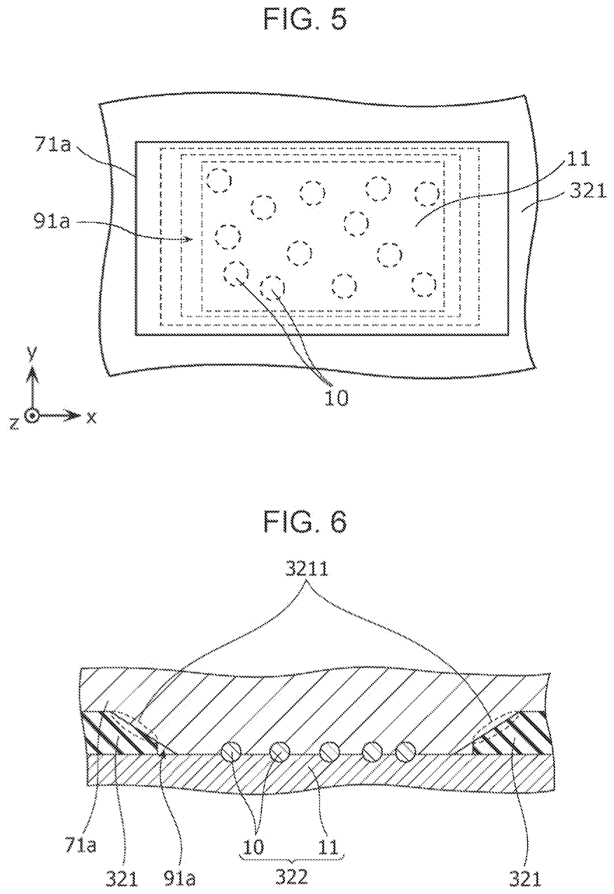

Next, a modification of the battery according to the first embodiment will be described with reference to FIGS. 5 and 6, FIG. 5 is a plan view illustrating a positional relationship between an inner terminal electrode 71a, an inner opening 91a, and the structures 10 according to the modification of the first embodiment. More specifically described, FIG. 5 corresponds to FIG. 3, which was explained in the first embodiment. FIG. 6 is a magnified sectional view illustrating an area including the structures 10 of the battery according to the modification of the first embodiment.

The modification differs from the first embodiment in the connection between the inner terminal electrodes and the metal layer 322. The battery according to the modification has the same configuration as the battery 1 according to the first embodiment except for the above. Here, the inner terminal electrode 71a is used for explanation.

In this modification, as illustrated in FIG. 5, the inner opening 91a is positioned inwardly from the inner terminal electrode 71a in plan view. Furthermore, the structures 10 are positioned in the inner opening 91a over a contact area between the inner terminal electrode 71a and the metal layer body 11.

In this modification, the inner resin layer 321 is deformed when the power generating element is pressed in the production process. For example, as illustrated in FIG. 6, areas 3211 indicated by broken circles are where the inner resin layer 321 is deformed.

This allows the structures 10 to be embedded in the inner terminal electrode 71a and the metal layer body 11. The metal layer body 11 may be deformed, or the metal layer body 11 and the inner terminal electrode may be deformed.

Second Embodiment

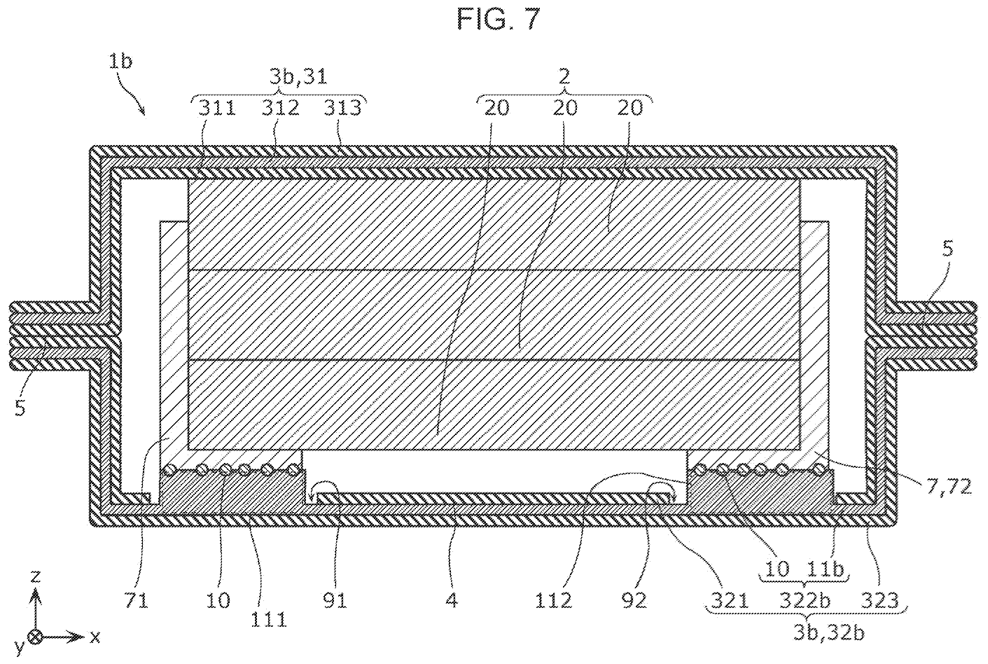

Next, a battery according to a second embodiment will be described with reference to FIG. 7. FIG. 7 is a sectional view illustrating a schematic configuration of a battery 1b according to this embodiment.

The second embodiment differs from the first embodiment in the thickness of portions of a metal layer 322b in the inner openings 91 and 92.

Specifically described, the battery 1b has the same configuration as the battery 1 according to the first embodiment except that portions of the metal layer 322b exposed, through the inner openings 91 and 92 is thicker than an unexposed portion of the metal layer 322b (here, a metal layer body 11b).

As illustrated in FIG. 7, in the battery 1b, a second laminate film 32b constituting a. portion of a laminate film 3b includes the inner resin layer 321, the metal layer 322b, and the outer resin layer 323. Furthermore, the metal layer 322b includes the structures 10 and the metal layer body 11b. Portions of the metal layer bodies 11b at the inner openings 91 and 92 are areas 111 and 112 each indicated by a broken line in FIG. 7. The portions of the metal layer body 11 b in the areas 111 and 112 are thicker than the unexposed portions of the metal layer 322b (where the metal layer 322b is sandwiched between the inner resin layer 321 and the outer resin layer 323).

This allows the structures 10 to increase in size, reducing the displacement of the power generating element 2 in the production process. Furthermore, this reduces damage to the metal layer body 11b in a contact region between the structures 10 and the metal layer body 11b, which may be caused when the power generating element 2 is pressed in the production process. This further improves the reliability of the battery 1b. The thickness of the metal layer body 11b in the areas 111 and 112 is, for example, greater than or equal to a few hundreds of μm and less than or equal to 1 mm.

The metal layer 322b of the second laminate film 32b is not thick over the entire area, and thus the weight of the second laminate film 32b is unlikely to increase. This increases the gravimetric energy density of the battery 1b. Furthermore, this allows the second laminate film 32b to keep flexibility, increasing productivity of the battery 1b, and resulting in a lower cost.

Third Embodiment

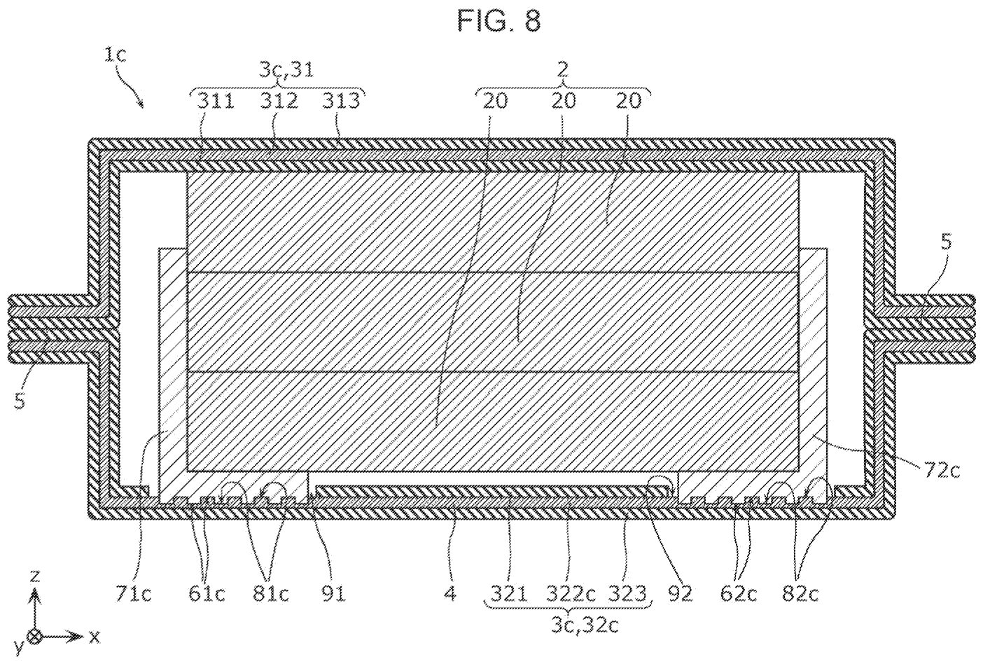

Next, a battery according to a third embodiment will be described with reference to FIG. 8. FIG. 8 is a sectional view illustrating a schematic configuration of a battery 1c according to this embodiment.

The battery 1c according to this embodiment has the same configuration as the battery 1 according to the first embodiment except for the following two features: the battery 1c does not have the structures 10; and protrusions of uneven surfaces 61c and 62c and uneven surface 81c and 82c each have a rectangular sectional shape.

In this embodiment, inner terminal electrodes 71c and 72c respectively have the uneven surfaces 61c and 62c, and a metal layer 322c has the uneven surfaces 81c and 82c. The uneven surfaces 61c and 62c and the uneven surfaces 81c and 82c have the protrusions each having a rectangular sectional shape and arranged in a stripe pattern extending in the y axis direction in plan view. However, the shape of the uneven surfaces 61c, 62c, 81c, and 82c should not be limited to this. For example. The one of the uneven surface 61c and the uneven surface 81c or one of the uneven surface 62c and the uneven surface 82c may have protrusions each having a cubic shape, and the protrusions may be arranged in a matrix or in a random pattern in plan view.

The battery 1c according to this embodiment is produced by the same method as the battery 1 according to the first embodiment. An example of the method is described below.

Before the inner terminal electrodes 71c and 72c are connected to the power generating element 2, the uneven surfaces 61c and 62c are formed in the bottom surfaces of the inner terminal electrodes 71c and 72c. Examples of the technique for producing the uneven surfaces 61c and 62c include, but are not limited to, blasting, etching, and laser processing.

Then, the power generating element 2 to which the inner terminal electrodes 71c and 72c are connected is placed on a second laminate film 32c included in the laminate film 3c, and then the power generating element 2 and the inner terminal electrodes 71c and 72c are pressed.

In this case, before the power generating element 2 and the inner terminal electrodes 71c and 72c are pressed, the surface of the metal layer 322c of the second laminate film 32c is flat in the inner openings 91 and 92. In other words, when the power generating element 2 and the inner terminal electrodes 71c and 72c are pressed, the uneven surfaces 81c and 82c are formed in the metal layer 322c and the uneven surfaces 61c and 62c are respectively engaged with the uneven surfaces 81c and 82c.

In the production process, the uneven surfaces 61c and 62c and the uneven surfaces 81c and 82c make the power generating elements 2 less movable relative to the second laminate film 32c, or fix the position of the power generating element 2. In other words, the power generating element 2 is positioned. Furthermore, in the production process, the power generating element 2 is subjected to an external force generated by an atmospheric airflow caused when the pressure is increased to an ordinary pressure and an external force generated by deformation and displacement of the laminate film 3c caused by the airflow. The engagement between the uneven surface 61c and the uneven surface 81c and the engagement between the uneven surface 62c and the uneven surface 82c limit the movement of the power generating element 2 when the external forces are applied to the power generating element 2. This reduces the displacement of the power generating element 2.

Furthermore, this eliminates the need for an adhesive in the positioning of the power generating element, reducing volatilization of a volatile substance from the adhesive in the enfolding step. Thus, the performance of the power generating element 2 is less likely to be lowered by the volatile substance. Furthermore, the absence of an adhesive reduces warping of the power generating element 2, which may be caused by curing of an adhesive.

In other words, the battery 1c allows easy positioning of the power generating element 2 and the laminate film 3c relative to each other and has high reliability.

The uneven surfaces 61c and 62c may be formed in the bottom surface of the inner terminal electrodes 71c and 72c after the inner terminal electrodes 71c and 72c are connected to the power generating element 2. Furthermore, the bottom surfaces of the inner terminal electrodes 71c and 72c may be flat before the power generating element 2 and the inner terminal electrodes 71c and 72c are pressed, and the metal layer 322c may have the uneven surfaces 81c and 82c at portions in the inner openings 91 and 92. In such a case, the uneven surfaces 61c and 62c are formed in the bottom surfaces of the inner terminal electrodes 71c and 72c when the power generating element 2 and the inner terminal electrodes 71c and 72c are pressed.

Fourth Embodiment

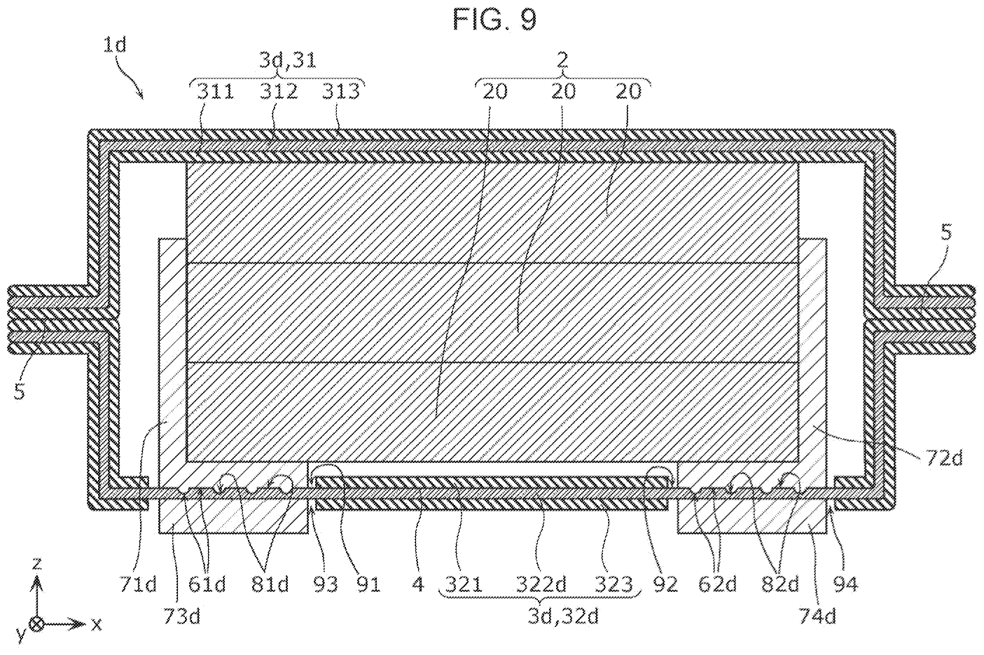

Next, a battery according to a fourth embodiment will be described with reference to FIG. 9. FIG. 9 is a sectional view illustrating a schematic configuration of a battery id according to this embodiment.

The battery 1d according to this embodiment has the same configuration as the battery 1c according to the third embodiment except for the following three features: protrusions of uneven surfaces 61d and 62d each have a semi-circular sectional shape and recesses of uneven surfaces 81d and 82d each have a semi-circular sectional shape; the outer resin layer 323 has outer openings 93 and 94; and the battery 1d includes outer terminal electrodes 73d and 74d.

In this embodiment, inner terminal electrodes 71d and 72d have the uneven surfaces 61d and 62d, and a metal layer 322d has the uneven surfaces 81d and 82d. The uneven surfaces Old and 62d have the protrusions each having a semi-circular sectional shape and arranged in a striped pattern extending in the y axis direction in plan view. However, the shape of the uneven surfaces 61d and 62d should not be limited to this. The protrusions of the uneven surfaces 61d and 62d also may be semi-spherical and may be arranged in a matrix or in a random pattern in plan view. The shape of the protrusions of the uneven surfaces 61d and 62d should not be limited to the above-described shape, For example, the protrusions of the uneven surfaces 61d and 62d may have a curved surface.

The recesses of the uneven surfaces 81d and 82d may have any shape corresponding to the protrusions of the uneven surfaces 61d and 62d. For example, the recesses may be semi-spherical.

A laminate film 3d according to this embodiment includes the first laminate film 31, a second laminate film 32d, and the sealing portion 5. Furthermore, the second laminate film 32d includes the inner resin layer 321, the metal layer 322d, and the outer resin layer 323.

The outer resin layer 323 has the outer openings 93 and 94, which are spaces through which the metal layer 322d is exposed. In other words, the metal layer 322d has portions not covered by the outer resin layer 323 at the outer openings 93 and 94. In this embodiment, the outer openings 93 and 94 are located on an opposite side of the metal layer 322d from the inner openings 91 and 92, respectively. The outer openings 93 and 94 extend in the y axis direction in FIG. 9.

The outer terminal electrodes 73d and 74d are terminals electrically connected to the metal layer 322d through the outer openings 93 and 94. The outer terminal electrodes 73d and 74d draw current from the power generating element 2 through the metal layer 322d and the inner terminal electrodes 71d and 72d.

The outer terminal electrodes 73d and 74d each have a plate-like shape and have a surface connected to the metal layer 322d. However, the shape of the outer terminal electrodes 73d and 74d should not be limited to the above.

The positions of the outer openings 93 and 94 should not be limited to the above. The outer openings 93 and 94 may be located at any position that enables the current draw from the power generating element 2 through the metal layer 322d and the inner terminal electrodes 71d and 72d.

The battery 1d according to this embodiment is produced by the same method as the battery 1 according to the first embodiment. An example of the method is described below.

Before the inner terminal electrodes 71d and 72d are connected to the power generating element 2, the uneven surfaces 61d and 62d are formed in the bottom surfaces of the inner terminal electrodes 71d and 72d.

Then, the power generating element 2 to which the inner terminal electrodes 71d and 72d are connected is placed on the second laminate film 32d having the inner openings 91 and 92 and the outer openings 93 and 94, and the power generating element 2 and the inner terminal electrodes 71d and 72d are pressed.

In this case, before the power generating element 2 and the inner terminal electrodes 71c and 72c are pressed, the surface of the metal layer 322d is flat at the inner openings 91 and 92. In other words, when the power generating element 2 and the inner terminal electrodes 71d and 72d are pressed, the uneven surfaces 81d and 82d are formed in the metal layer 322d, allowing engagement between the uneven surface 81d and 81d and engagement between the uneven surfaces 62d and 82d.

As in the third embodiment, the battery id having the above-described configuration allows easy positioning of the power generating element 2 and the laminate film 3d relative to each other and has high reliability.

Furthermore, the outer terminal electrodes 73d and 74d are disposed in the outer openings 93 and 94 to be electrically connected to the metal layer 322d. The presence of the outer openings 93 and 94 enables current draw from the power generating element 2 through the metal layer 322d at each of the outer openings 93 and 94. This increases the freedom in design for current draw from the battery 1d. Furthermore, the outer terminal electrodes 73d and 74d can draw current through the outer openings 93 and 94, respectively. Thus, this increases the freedom in design for positioning of the outer terminal electrodes 73d and 74d.

Other Embodiments

The battery according to one or more aspects of the present disclosure was described above with reference to the embodiments and the modification, but the present disclosure should not be limited to the embodiments and the modification. Without departing from the spirit of the present disclosure, various changes may be added to the embodiments and the modification by a person skilled in the art and the components in different embodiments and modifications may be combined. They are construed as being within the scope of the present disclosure.

For example, the structure may have a higher elasticity than the inner terminal electrode or the metal layer body, whichever has higher elasticity. Furthermore, the structure may have higher hardness than the inner terminal electrode or the metal layer body, whichever has higher hardness. Here, the hardness may be defined as the Rockwell hardness, the Vickers hardness, the Brinell hardness, or Shore hardness, for example, but should not be limited thereto. The above-described configuration enables the structures to be readily embedded in the inner terminal electrodes and the metal layer body.

Other various modifications, substitutions, additions, or omissions may be performed on the embodiments within or equivalent to the scope of the claims.

The battery according to this disclosure may be used as, for example, an in-car battery or a battery installed in various electric devices

What is claimed is:

1. A battery comprising:
a power generating element including a positive electrode layer, a negative electrode layer, and an electrolyte layer between the positive electrode layer and the negative electrode layer;
an inner terminal electrode electrically connected to the power generating element; and
a laminate film accommodating the power generating element and the inner terminal electrode, wherein
the laminate film includes
a metal layer,
an inner resin layer that is located closer to the power generating element than the metal layer, and
an outer resin layer on an opposite side of the metal layer from the inner resin layer,
the inner resin layer has an inner opening through which the metal layer is exposed,
the inner terminal electrode is electrically connected to the metal layer through the inner opening,
the inner terminal electrode and the metal layer each have an uneven surface over a contact area between the inner terminal electrode and the metal layer, and
the uneven surface of the inner terminal electrode and the uneven surface of the metal layer engage with each other.

2. The battery according to claim 1, wherein the metal layer includes a metal layer body and a structure, and
a portion of the structure constitutes a protrusion of the uneven surface of the metal layer.

3. The battery according to claim 2, wherein the structure is electrically conductive.

4. The battery according to claim 2, wherein the structure is formed of metal.

5. The battery according to claim 2, wherein the structure is a spherical particle.

6. The battery according to claim 1, wherein the inner terminal electrode is in contact with a side surface and a main surface of the power generating element.

7. The battery according to claim 1, wherein the outer resin layer has an outer opening through which the metal layer is exposed.

8. The battery according to claim 7, further comprising an outer terminal electrode electrically connected to the metal layer through the outer opening.

9. The battery according to claim 1, wherein a portion of the metal layer exposed through the inner opening is thicker than an unexposed portion of the metal layer.

10. The battery according to claim 1, wherein the electrolyte layer is a solid electrolyte layer including a solid electrolyte that conducts lithium ions.

11. A method of producing a battery that includes a power generating element including a positive electrode layer, a negative electrode layer, and an electrolyte layer between the positive electrode layer and the negative electrode layer, an inner terminal electrode, and a laminate film accommodating the power generating element and the inner terminal electrode, the method comprising:
providing the laminate film including a metal layer and an inner resin layer, the inner resin layer being located closer to the power generating element than the metal layer and having an inner opening through which the metal layer is exposed;
placing a structure in the inner opening; and
pressing the inner terminal electrode electrically connected to the power generating element to be electrically connected to the metal layer through the inner opening having the structure placed in the placing.
